(19) United States
(12) Patent Application Publication
(10) Pub. No.: US 2026/0298130 A1
(43) Pub. Date: Oct. 1, 2026

(54) METHOD FOR CONTROLLING AN ENGINE COOLING SYSTEM, AN ENGINE COOLING SYSTEM AND A VEHICLE HAVING THE SAME

(71) Applicants: HYUNDAI MOTOR COMPANY, Seoul (KR); KIA CORPORATION, Seoul (KR)

(72) Inventors: JeongEui Kong, Hwaseong-si (KR); Ho Kyoun Kang, Hwaseong-si (KR); JiSung Park, Hwaseong-si (KR); Hee Yong Choi, Hwaseong-si (KR)

(73) Assignees: HYUNDAI MOTOR COMPANY, Seoul (KR); KIA CORPORATION, Seoul (KR)

(21) Appl. No.: 19/323,558

(22) Filed: Sep. 9, 2025

(30) Foreign Application Priority Data
Mar. 28, 2025 (KR) 10-2025-0040257

(51) Int. Cl. F01P 7/14

(52) U.S. Cl. CPC F01P 7/14; F01P 2007/146; F01P 2025/33; F01P 2025/62; F01P 2025/64

(57) ABSTRACT

A method for controlling an engine cooling system includes: collecting driving state information of a vehicle having an engine; determining a cooling logic entry condition of an engine block based on a load state relative to an RPM value of the engine; controlling a block-side opening amount of an integrated flow control valve connected to the engine based on whether the cooling logic entry condition is satisfied; and determining a cooling logic escape condition of the engine block based on the load state relative to the RPM value of the engine.

### CROSS-REFERENCE TO RELATED APPLICATIONS

This application claims benefit of and priority to Korean Patent Application No. 10-2025-0040257, filed on Mar. 28, 2025, the disclosure of which is incorporated herein by reference in its entirety.

### FIELD

The present disclosure relates to a method for controlling an engine cooling system, an engine cooling system, and a vehicle including the same.

### BACKGROUND

When using an internal combustion engine (hereinafter, referred to as an engine) as a power source of a vehicle, an engine cooling system is necessary, since when the engine overheats, a problem such as damage to components may occur and normal operations cannot be performed.

The engine cooling system uses coolant to cool the engine, and an Integrated Thermal Management Valve (ITM) is used to efficiently distribute the coolant.

Typically, an integrated flow control valve has an inlet for engine coolant to flow in and a plurality of ports for allowing the coolant to flow out in different directions. The integrated flow control valve may optimize a heat exchange performance of the engine coolant, whose temperature varies according to the operating conditions of the engine, by controlling a flow rate of the inlet or multiple ports.

The statements in this section merely provide background information related to the present disclosure and may not constitute prior art.

### SUMMARY

Embodiments of the present disclosure provide a method for controlling an engine cooling system, an engine cooling system, and a vehicle including the same, that can prevent engine overheating and damage to components of a vehicle and efficiently operate an engine cooling system.

Embodiments of the present disclosure further prevent an engine block from overheating even during high-load driving, by controlling a flow of coolant by determining cooling logic entry/escape conditions of the engine block.

According to an aspect of the present disclosure, provided is a method for controlling an engine cooling system, an engine cooling system, and a vehicle including the same as follows.

According to an embodiment of the present disclosure, a method for controlling an engine cooling system, performed by a processor of a computing device executing instructions stored on a non-transitory computer-readable medium, may include: collecting driving state information of a vehicle including an engine, determining whether a cooling logic entry condition of an engine block is satisfied based on a load state relative to an RPM value of the engine; controlling a block-side opening amount of an integrated flow control valve connected to the engine based on whether the cooling logic entry condition is satisfied, and determining a cooling logic escape condition of the engine block based on the load state relative to the RPM value of the engine.

According to an embodiment of the present disclosure, an engine cooling system includes: an integrated flow control valve configured to distribute coolant flowing in from an engine through one or more inlets, a plurality of circulation paths configured to circulate the coolant distributed by the integrated flow control valve into an internal path of the engine, and a control unit configured to control the integrated flow control valve. In particular, the control unit is configured to: determine a cooling condition of an engine block based on a load state in relation to an RPM value of the engine, and adjust an opening amount of a block-side inlet connected to the engine block based on whether the cooling condition is satisfied.

According to an embodiment of the present disclosure, a vehicle includes an engine having a block and a head, an integrated flow control valve configured to distribute coolant flowing in through at least one of a block-side inlet and a head-side inlet to a plurality of outlets, a plurality of circulation paths configured to circulate the coolant distributed to the plurality of outlets into an internal path of the engine, and a control unit configured to control the integrated flow control valve. In particular, the control unit may determine a cooling condition of the block based on a load state relative to an RPM value of the engine, and adjust an opening amount of the block-side inlet based on whether the cooling condition is satisfied.

### BRIEF DESCRIPTION OF DRAWINGS

The above and other aspects, features, and advantages of the present disclosure are more clearly understood from the following detailed description, taken in conjunction with the accompanying drawings, in which:

FIG. 1 is a block diagram illustrating a vehicle according to an embodiment of the present disclosure;

FIG. 2 is an exploded perspective view illustrating some configurations of an engine cooling system according to an embodiment of the present disclosure;

FIG. 3 is a flow chart illustrating a method for controlling an engine cooling system according to an embodiment of the present disclosure;

FIG. 4 is a flow chart illustrating a method for controlling an engine cooling system according to an embodiment of the present disclosure;

FIG. 5 is a flow chart illustrating a method for controlling an engine cooling system according to an embodiment of the present disclosure;

FIG. 6 is an exemplary graph illustrating a method for controlling an engine cooling system according to an embodiment of the present disclosure;

FIG. 7A is a graph illustrating experimental results according to a comparative example;

FIG. 7B is an exemplary graph illustrating experimental results according to a method for controlling an engine cooling system according to an embodiment of the present disclosure; and

FIG. 8 is a block diagram of a computing device that is configured to fully or partially implement a control unit of an engine cooling system according to an embodiment of the present disclosure.

The drawings described herein are for illustration purposes only and are not intended to limit the scope of the present disclosure in any way.

### DETAILED DESCRIPTION

Hereinafter, specific embodiments of the present disclosure are described with reference to the drawings. The detailed descriptions that follow are provided to facilitate a comprehensive understanding of the methods, devices and/or systems described herein. However, this is merely an example and the present disclosure is not limited thereto.

In describing the embodiments of the present disclosure, if it is determined that the detailed description of the known technology related to the present disclosure may unnecessarily obscure the subject matter of the present disclosure, the detailed description thereof has been omitted. In addition, terms to be described later are terms defined in consideration of functions in the present disclosure, which may vary according to the intention or custom of a user or operator. Therefore, the definition should be made based on the contents throughout this specification. The terminology used in the detailed description is only for describing the embodiments of the present disclosure and should in no way be limiting. Unless expressly used otherwise, singular forms of expression include plural forms.

In addition, throughout the specification, when a part is said to be ‘connected’ to another part, it is not only ‘directly connected,’ but also ‘indirectly connected’ with other components interposed therebetween. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” are intended to encompass any one of the listed elements and any combination of two or more of the listed elements, unless otherwise explicitly stated.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

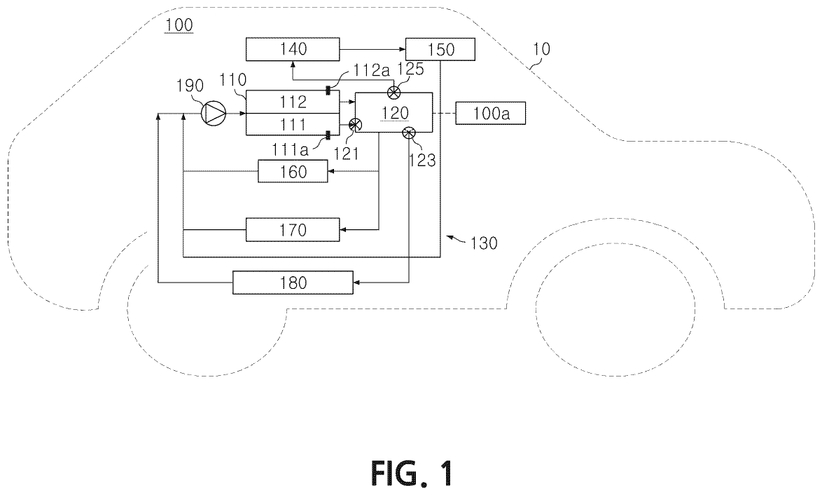

FIG. 1 illustrates a block diagram of a vehicle according to an embodiment of the present disclosure. Referring to FIG. 1, a vehicle 10 may include an engine cooling system 100.

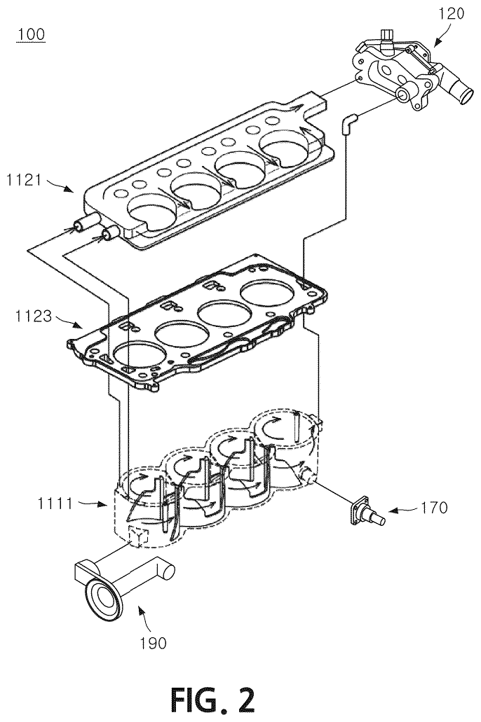

FIG. 2 is an exploded perspective view illustrating some configurations of the engine cooling system 100.

Referring to FIGS. 1 and 2 together, the engine cooling system 100 may include an engine 110, an integrated flow control valve 120, a plurality of circulation paths 130, an EGR cooler 140, a heater 150, an EGR valve 160, an oil cooler 170, a radiator 180, a water pump 190, and a control unit 100a.

The engine 110 may include a cylinder block 111, a cylinder head 112, a block coolant temperature sensor 111a, and a head coolant temperature sensor 112a.

The cylinder block 111 may include a block coolant chamber 1111 having coolant flowing therein.

The cylinder head 112 may be disposed on the cylinder block 111. A head gasket 1123 may be interposed between the cylinder block 111 and the cylinder head 112.

The cylinder head 112 may include a head coolant chamber 1121 having coolant flowing therein.

A front side of the engine 110 may be connected to a water pump 190, and a rear side of the engine 110 may be connected to an integrated flow control valve 120. Coolant pumped by the water pump 190 may be supplied to a front side of the cylinder block 111.

A portion of the coolant pumped to the front side of the cylinder block 111 may be supplied to a front side of the cylinder head 112 through a head gasket 1123, and the remaining coolant may flow to a rear side of the cylinder block 111.

Coolant supplied to the interior of the cylinder block 111 and the cylinder head 112 may be supplied to an integrated flow control valve 120. The integrated flow control valve 120 may control a flow rate of coolant flowing in from the engine 110.

By the operation of the water pump 190, the coolant may be circulated along a plurality of circulation paths 130 of the engine cooling system 100.

The block coolant temperature sensor 111a may be installed inside the cylinder block 111, and detect a coolant temperature inside the cylinder block 111.

The head coolant temperature sensor 112a may be installed inside the cylinder head 112, and detect a coolant temperature inside the cylinder head 112.

The integrated flow control valve 120 may include one or more inlets and one or more outlets.

The integrated flow control valve 120 may receive coolant from the engine 110 through one or more inlets thereof.

For example, the integrated flow control valve 120 may receive coolant from a block-side inlet connected to the interior of the cylinder block 111 and a head-side inlet connected to the interior of the cylinder head 112.

The integrated flow control valve 120 may distribute coolant to the EGR cooler 140, the EGR valve 160, the oil cooler 170, and the radiator 180.

The integrated flow control valve 120 may control a flow rate of a block-side inlet 121 connected to the interior of the cylinder block 111, a flow rate of a radiator-side outlet 123 supplying coolant to the radiator 180, and a flow rate of an EGR cooler-side outlet 125 supplying coolant to the EGR cooler 140.

In an embodiment, an integrated flow control valve 120 may be configured to constantly supply coolant to the EGR cooler 140 and the oil cooler 170.

The plurality of circulation paths 130 may circulate coolant distributed by the integrated flow control valve 120. The coolant distributed by the integrated flow control valve 120 may be circulated back to the water pump 190 and the internal path of the engine 110 through the plurality of circulation paths 130.

The EGR cooler 140 may cool EGR gas (recirculated exhaust gas), and the heater 150 may heat the interior air of the vehicle 10.

The radiator 180 may release heat of coolant externally.

The oil cooler 170 may cool oil circulating through the engine.

The control unit 100a may include one or more processors.

The control unit 100a may generate a coolant flow control signal adjusting at least one of a flow rate of one or more inlets or a flow rate of one or more outlets of the integrated flow control valve 120.

The control unit 100a may control the integrated flow control valve 120 based on the coolant flow control signal.

The control unit 100a may determine a cooling condition of the engine block (cylinder block 111) based on the load state in relation to the RPM (revolutions per minute) value of the engine 110. The cooling condition may include a cooling logic entry condition and a cooling logic escape condition.

The control unit 100a may generate a control signal for adjusting an opening amount of a block-side inlet connected to the engine block depending on whether the cooling condition is satisfied.

The control unit 100a may collect driving state information of a vehicle 10. For example, the control unit 100a may receive driving state information from another controller included in the vehicle 10.

The driving state information of the vehicle 10 may include, for example, an RPM value of an engine 110, an accelerator pedal operation amount (e.g., a degree of accelerator pedal depression) of the vehicle 10, and a percent (%) engine load value (i.e., an engine load value expressed as a percentage of maximum output) of the engine 110.

The control unit 100a may derive the load state relative to the RPM value of the engine 110 based on the driving state information of the vehicle 10.

The control unit 100a may determine a first condition based on whether the accelerator pedal operation amount is greater than or equal to a reference accelerator pedal operation amount determined according to the RPM value of the engine 110.

In an embodiment, the reference accelerator pedal operation amount may be set to be lower as the RPM value of the engine 110 increases.

The control unit 100a may determine a second condition based on whether a % load value of the engine 110 is greater than or equal to a reference % load determined according to the RPM value of the engine 110. The % load may refer to a ratio of an output to a maximum output of the engine 110.

In an embodiment, the reference % load may be set to be lower as the RPM value of the engine 110 increases.

The control unit 100a may determine that a cooling logic entry condition of an engine block is satisfied when a maintenance time in a high-load state in which at least one of the first condition and the second condition is satisfied is longer than or equal to a preset reference maintenance time. The term ‘cooling logic entry condition’ refers to a condition under which the control unit initiates or activates a cooling control operation for the engine block.

According to an embodiment of the present disclosure, the cooling logic of the engine block is entered only when the maintenance time in the high-load state is longer than or equal to a preset reference maintenance time, thereby preventing unnecessary cooling of the engine block.

The control unit 100a may control an opening amount of the block-side inlet 121 to a first set value to resume coolant flow to the engine block when the cooling logic entry condition is satisfied.

The control unit 100a may receive a measured value of the head coolant temperature sensor 112a.

The control unit 100a may optionally control the opening amount of the block-side inlet 121 to a second set value, smaller than the first set value when the measured value of the head coolant temperature sensor 112a is lower than a reference head temperature.

When the measured value of the head coolant temperature sensor 112a is lower than the reference head temperature, it may be determined that an engine head is not overheated, and in this case, the opening amount of the block-side inlet 121 may be set to be relatively small to prevent excessive or unnecessary cooling of the engine block. This allows the engine cooling system to operate efficiently.

The control unit 100a may count an escape delay time from a point in time at which both the first condition and the second condition are not satisfied.

The control unit 100a may determine that a cooling logic escape condition is satisfied when the escape delay time is greater than or equal to a preset reference delay time.

According to an embodiment of the present disclosure, the cooling logic of the engine block is escaped or exited only when the escape delay time is longer than or equal to a preset reference delay time, which helps prevent frequent operation of the flow control valve and thereby contributes to improved durability of the cooling system.

When the cooling logic escape condition is satisfied, the control unit 100a may return the opening amount of the block-side inlet 121 of the integrated flow control valve 120 to the value that was set prior to satisfaction of the cooling logic entry condition.

The control unit 100a may reset the counting of the escape delay time when a high load state in which at least one of the first condition and the second condition is satisfied occurs.

According to an embodiment of the present disclosure, when a high load state occurs during the counting of the escape delay time, by resetting the counting of the escape delay time, frequent operation of the flow control valve in a situation in which re-acceleration occurs immediately after the cooling logic escape can be prevented, thereby improving the durability of the cooling system.

According to an embodiment of the present disclosure, when an escape delay time is applied, and also a cooling logic entry condition is satisfied during the counting of the escape delay time, by resetting the escape delay time, it is possible to prevent a liner metal surface from exceeding a temperature limit, even under harsh conditions such as repeated TIP-IN/OUT behavior, where re-acceleration occurs immediately after the cooling logic is exited.

According to an embodiment of the present disclosure, by determining the cooling logic entry/escape condition of the engine block and controlling a flow of coolant, the engine block may be prevented from overheating even during high-load operation.

It can prevent siamese portion of engine liner from exceeding the temperature limit, and has the effect of preventing cracks from occurring in the liner due to a difference in thermal expansion coefficients between the block and the liner.

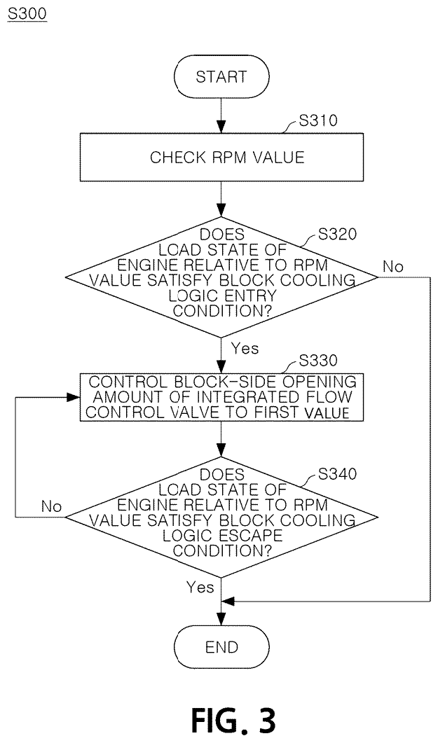

FIG. 3 is a flowchart of a method for controlling an engine cooling system according to an embodiment of the present disclosure. Referring to FIG. 3, a method for controlling an engine cooling system (S300) may include an operation (S310) of checking an RPM value of a vehicle, an operation (S320) of determining a cooling logic entry condition of an engine block based on a load state in relation to an RPM value of an engine, an operation (S330) of controlling an opening amount of a block-side inlet of an integrated flow control valve to a first value, and an operation (S340) of determining a cooling logic escape condition of the engine block based on the load state relative to the RPM value of the engine.

The method for controlling an engine cooling system (S300) may include an operation of collecting driving state information of a vehicle. The driving state information may include an RPM value of an engine, an accelerator pedal operation amount of a vehicle, and a % (percent) load value of the engine.

The operation (S320) of determining the cooling logic entry condition of the engine block may include an operation of deriving a load state relative to an RPM value of an engine based on driving state information of a vehicle. Whether the cooling logic entry condition of the engine block is satisfied may be determined based on the load state in relation to the RPM value of the engine.

The operation (S320) of determining the cooling logic entry condition of the engine block may further include an operation of determining a first entry condition based on whether an accelerator pedal operation amount is greater than or equal to a reference accelerator pedal operation amount determined according to the RPM value of the engine, and an operation of determining a second entry condition based on whether a load % value of the engine is greater than or equal to a reference % load determined according to the RPM value of the engine.

In the operation (S320) of determining the cooling logic entry condition of the engine block, it may be determined that the cooling logic entry condition is satisfied when a maintenance time in a high load state in which at least one of the first entry condition and the second entry condition is satisfied is longer than or equal to a preset reference maintenance time.

According to an embodiment of the present disclosure, the cooling logic of the engine block is entered only when the maintenance time in the high load state is longer than or equal to the preset reference maintenance time, thereby preventing unnecessary cooling of the engine block and preventing frequent operation of the flow control valve, thereby contributing to improving the durability of the cooling system.

When it is determined that the cooling logic entry condition is satisfied in S320, an operation (S330) of controlling an opening amount of a block-side inlet of the integrated flow control valve to a first value may proceed.

The opening amount of the block-side inlet of the integrated flow control valve may be controlled to the first value so that coolant flow to the engine block may be resumed.

If it is determined that the cooling logic entry condition is not satisfied in S320, the method for controlling an engine cooling system (S300) may be terminated.

In an embodiment, the method for controlling an engine cooling system (S300) may further include an operation of receiving coolant temperature information of an engine head.

The operation (S330) of controlling an opening amount of a block-side inlet to a first value may further include an operation of controlling the opening amount of the block-side inlet of the integrated flow control valve to a second value, which is smaller than the first value, when the coolant temperature of the engine head is lower than a reference head temperature.

This allows the engine cooling system to operate efficiently by preventing unnecessary excessive cooling of the engine block when the engine head is not overheated.

In the operation (S340) of determining a cooling logic escape condition of an engine block, it may be determined whether the cooling logic escape condition of the engine block is satisfied based on a load state in relation to an RPM value of an engine.

The operation (S340) of determining the cooling logic escape condition of the engine block may include: determining a first escape condition based on whether an accelerator pedal operation amount is greater than or equal to a reference accelerator pedal operation amount determined according to the RPM value of the engine, determining a second escape condition based on whether a % load value of the engine is greater than or equal to a reference % load determined according to the RPM value of the engine, and counting an escape delay time from a point in time at which both the first escape condition and the second escape condition are not satisfied.

The operation (S340) of determining the cooling logic escape condition of the engine block may determine that the cooling logic escape condition is satisfied when the escape delay time is longer than or equal to a preset reference delay time.

According to an embodiment of the present disclosure, the cooling logic of the engine block is escaped only when the escape delay time is longer than or equal to a preset reference delay time, thereby preventing frequent operation of the flow control valve, thereby contributing to improving the durability of the cooling system.

The operation of counting the escape delay time can reset the counting of the escape delay time when a high load state in which at least one of the first escape condition and the second escape condition is satisfied occurs.

If it is determined that the cooling logic escape condition is satisfied in S340, the method for controlling an engine cooling system (S300) may be terminated.

If it is determined that the cooling logic escape condition is not satisfied in S340, the operation (S330) of controlling the opening amount of the block-side inlet of the integrated flow control valve to the first value may proceed again.

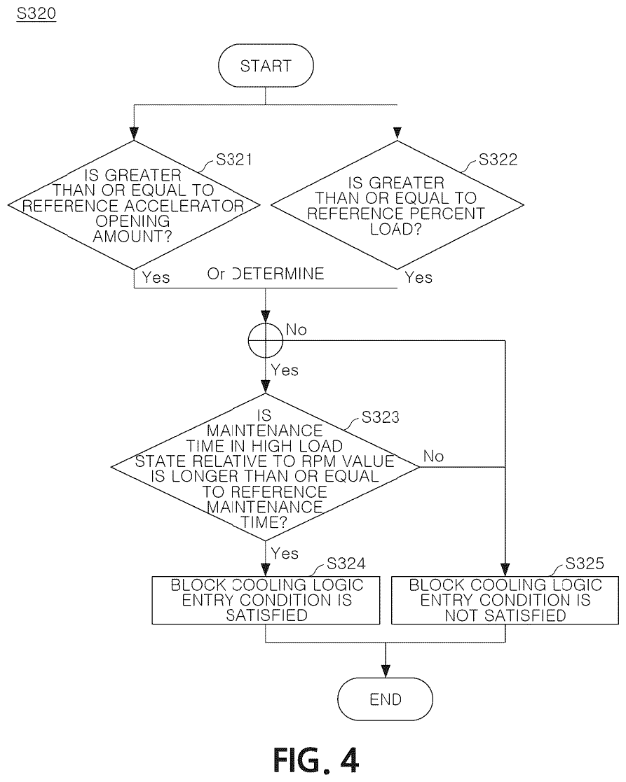

FIG. 4 is a detailed flowchart of an operation (S320) of determining a cooling logic entry condition of an engine block.

Referring to FIG. 4, in the operation (S320) of determining a cooling logic entry condition of an engine block, it may be determined whether an accelerator pedal operation amount is greater than or equal to a reference accelerator pedal operation amount determined according to an RPM value of an engine (in an operation S321), and it may be determined whether a % load value of the engine is greater than or equal to a reference % load determined according to the RPM value of the engine (in an operation S322).

When at least one of the determination made in the operations S321 and S322 is satisfied, it may be further determined whether a maintenance time of a high load state relative to the RPM value is longer than or equal to a preset reference maintenance time (in an operation S323).

When, in the operation S323, the maintenance time in the high load state relative to the RPM value is longer than or equal to a preset reference maintenance time, it may be determined that the cooling logic entry condition of the engine block is satisfied (in an operation S324).

When both conditions are not satisfied, as the determination results of S321 and S322, or when the maintenance time in the high load state relative to the RPM value is less than the preset reference maintenance time, as the determination result of S323, it may be determined that the cooling logic entry condition of the engine block is not satisfied (in an operation S325).

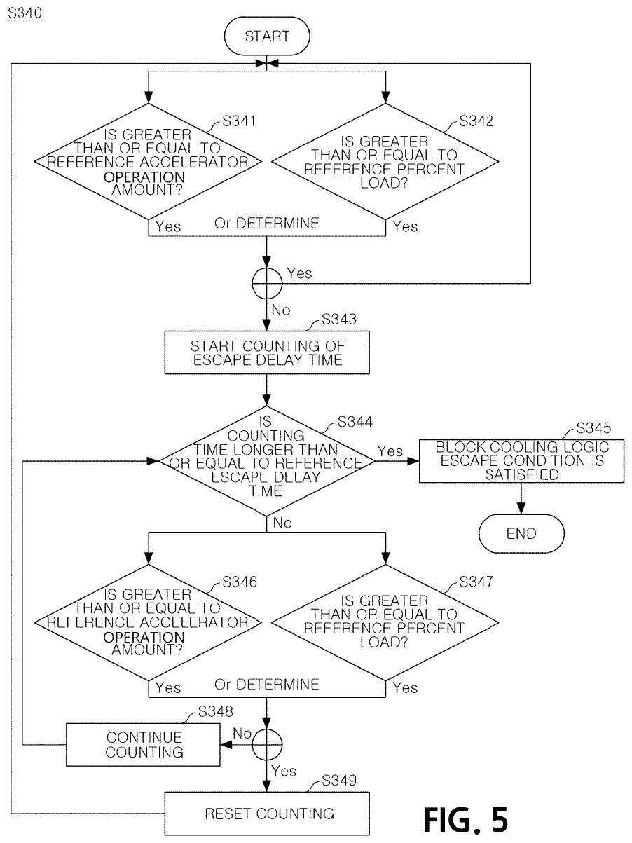

FIG. 5 is a detailed flowchart of an operation (S340) of determining a cooling logic escape condition of an engine block.

Referring to FIG. 5, in the operation (S340) of determining the cooling logic escape condition of the engine block, it may be determined that whether an accelerator pedal operation amount is greater than or equal to a reference accelerator pedal operation amount determined by an RPM value of an engine (in an operation S341), and it may be determined that whether a % load value of the engine is greater than or equal to a reference % load determined based on the RPM value of the engine (in an operation S342).

When the determination results of operations S341 and S342 indicate that both conditions are not satisfied, an escape delay time may be counted (in an operation S343).

When at least one of the determination results of operations S341 and S342 is satisfied, it is possible to return to a start operation.

Next, it may be determined whether an escape delay time counted according to operation S343 is greater than or equal to a preset reference delay time (in an operation S344).

When the escape delay time is longer than or equal to the preset reference delay time, it may be determined that the cooling logic escape condition of the engine block is satisfied (in an operation S345).

Meanwhile, when the escape delay time is less than the preset reference delay time, it may be determined that the accelerator pedal operation amount is greater than or equal to the reference accelerator pedal operation amount determined according to the RPM value of the engine (in an operation S346), and it may be determined whether the % load value of the engine is greater than or equal to the reference % load determined according to the RPM value of the engine (in an operation S347).

When both conditions are not satisfied as the determination results of operations S346 and S347, escape delay time counting may continue (in an operation S348), and it may be determined in an operation S344 whether the counted escape delay time is greater than or equal to a preset reference delay time.

When at least one of the determination results of S346 and S347 is satisfied, the counting of the escape delay time may be reset (in an operation S349).

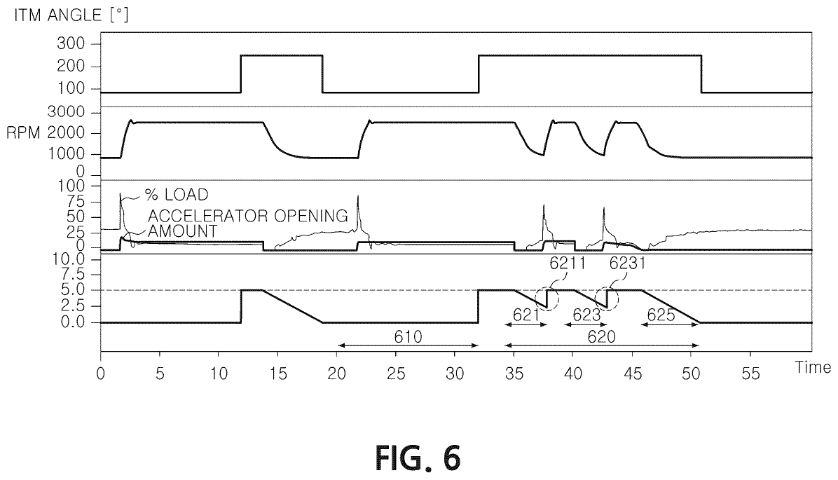

FIG. 6 is an exemplary graph illustrating that a method for controlling an engine cooling system according to an embodiment of the present disclosure is applied, which sequentially illustrates an opening amount of a block-side inlet of an integrated flow control valve, an RPM value of an engine, and an accelerator pedal operation amount, and a % load value of an engine.

Referring to FIG. 6, when a maintenance time in a high load state in which at least one of a first entry condition and the second entry condition is satisfied, is longer than or equal to a preset reference maintenance time, the block-side inlet of the integrated flow control valve may be opened at a preset value.

Next, an escape delay time may be counted from a point in time at which both a first escape condition and a second escape condition are not satisfied (621, 623, 625), and when a high load state occurs in which at least one of the first escape condition and the second escape condition is satisfied (6211, 6231), the counting of the escape delay time may be reset.

According to an embodiment of the present disclosure, by resetting an escape delay time, when the cooling logic entry condition is satisfied during the counting of the escape delay time, it is possible to prevent a liner metal surface from exceeding a limit temperature even in a harsh condition (e.g., repeated TIP-IN/OUT) in which re-acceleration occurs immediately after escaping the cooling logic.

When the escape delay time 625 exceeds the preset reference delay time, the block-side inlet of the integrated flow control valve may be controlled to the previous state.

Accordingly, a total delay time 620 for escaping the cooling logic of the engine block may be indicated as illustrated in FIG. 6.

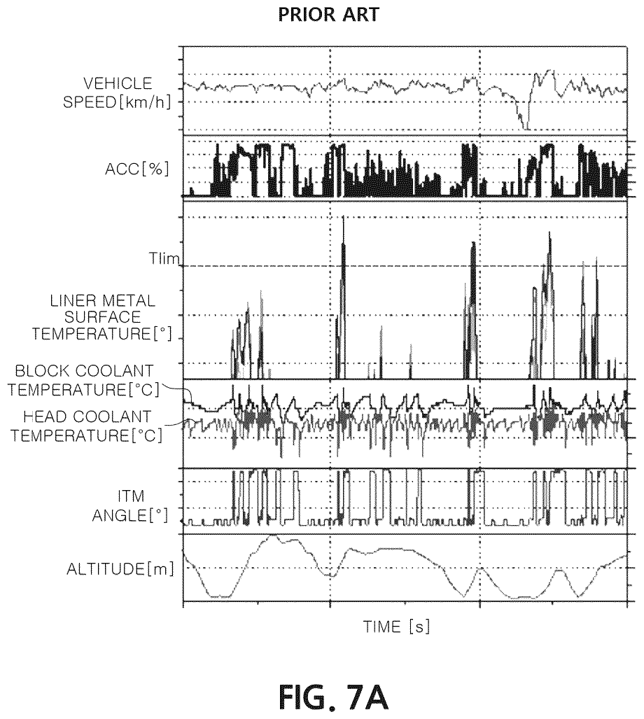

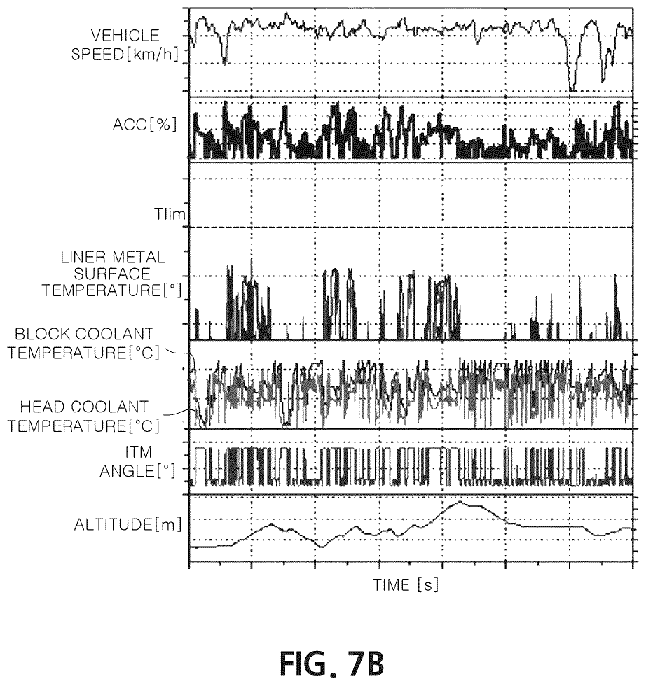

FIG. 7A is a graph illustrating experimental results according to a method for controlling an engine cooling system according to a comparative example. FIG. 7B is a graph illustrating experimental results according to a method for controlling an engine cooling system according to an embodiment of the present invention.

Comparing FIGS. 7A and 7B, in FIG. 7A, there was a case in which a temperature of a liner metal surface of the engine exceeds a limit temperature (Tₗᵢₘ), but in FIG. 7B, the temperature of the liner metal surface of the engine is stably maintained to be the limit temperature (Tₗᵢₘ) or less.

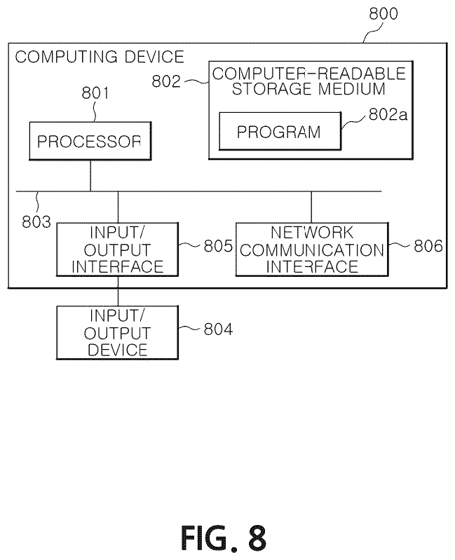

FIG. 8 is a block diagram of a computing device 500 that may fully or partially implement a vehicle 10 according to an embodiment of the present disclosure, and may include a control unit 100a included in the engine cooling system 100 of the vehicle 10 illustrated in FIG. 1.

As illustrated in FIG. 8, the computing device 800 includes at least one processor 801, a computer-readable storage medium 802, and a communication bus 803.

The processor 801 may cause the computing device 800 to operate according to the above-described exemplary embodiments. For example, the processor 801 may execute one or more programs store in the computer-readable storage medium 802. The one or more programs may include one or more computer executable instructions, wherein, when executed by the processor 801, the computer-readable executable instructions may be configured to cause the computing device 800 to perform operations according to an exemplary embodiment.

The computer-readable storage medium 802 is configured to store computer-executable instructions or program code, program data, and/or other suitable forms of information. A program 802a stored on the computer-readable storage medium 802 includes a set of instructions executable by the processor 801. In an embodiment, the computer-readable storage medium 802 may include a memory (a volatile memory such as a random access memory, a non-volatile memory, or a suitable combination thereof), one or more magnetic disk storage devices, optical disk storage devices, flash memory devices, other forms of storage media that can be accessed by the computing device 800 and store desired information, or suitable combinations thereof.

The communication bus 803 interconnects various other components of the computing device 800, including the processor 801 and the computer-readable storage medium 802.

The computing device 800 may also include one or more input/output interfaces 805 and one or more network communication interfaces 806 providing an interface for one or more input/output devices 804. The input/output interface 805 and the network communication interface 806 are connected to the communication bus 803.

The network communication interface 806 is an interface for communication within the vehicle or an interface for communication between the vehicle and other devices outside the vehicle, and may include, for example, a Controller Area Network (CAN), a Media Oriented Systems Transport (MOST) network, a Local Interconnect Network (LIN), and/or X-by-Wire (Flexray), Wi-Fi, Bluetooth, NFC, RFID, etc. The network may be either a cellular network, such as a global system for mobile communications (GSM), enhanced data rates for GSM evolution (EDGE), a general packet radio service (GPRS), a code division multiple access (CDMA), a time division CDMA(TD-CDMA), a universal mobile telecommunications system (UMTS), a long term evolution (LTE), or another cellular network.

The input/output device 804 may be connected to other components of the computing device 800 through the input/output interface 805. The exemplary input/output device 804 may include an input device such as a pointing device (a mouse, a trackpad, or the like), a keyboard, a touch input device (a touchpad, a touchscreen, or the like), a voice or sound input device, various types of sensor devices, and/or a photographing device, and an output device such as a display device, a printer, a speaker, and/or a network card. The exemplary input/output device 804 may be included inside the computing device 800 as a component constituting the computing device 800, or may be connected to the computing device 800 as a separate device, distinct from the computing device 800.

Meanwhile, embodiments of the present disclosure may include a program for performing the methods described in this specification on a computer, and a computer readable recording medium including the program. The computer-readable recording medium may include program instructions, local data files, local data structures, or the like, alone or in a combination thereof. The medium may be specially designed and configured for the present disclosure, or may be commonly available in the field of computer software. Examples of the computer-readable medium may include a hardware device specially configured to store a magnetic medium such as hard disks, floppy disks and magnetic tapes, an optical recording medium such as CD-ROMs and DVDs, and program instructions such as ROM, RAM, and a flash memory and perform the same. Examples of the program may include not only machine language codes generated by a compiler, but also high-level language codes that may be executed by a computer using an interpreter.

As set forth above, according to the present disclosure, a method for controlling an engine cooling system, an engine cooling system, and a vehicle including the same, which can prevent engine overheating and damage to components of a vehicle and efficiently operate the engine cooling system, may be provided.

According to the present disclosure, a method for controlling an engine cooling system, an engine cooling system, and a vehicle including the same, which can prevent an engine block from overheating even during high-load driving by controlling a flow of coolant by determining an entry/escape condition of a cooling logic of the engine block, and prevent a liner metal surface from overheating beyond a limit temperature, may be provided.

While certain embodiments have been illustrated and described above, it should be apparent to those having ordinary skill in the art that modifications and variations could be made without departing from the scope of the present disclosure as defined by the appended claims.

What is claimed is:

1. A method for controlling an engine cooling system, the method comprising:
collecting driving state information of a vehicle that includes an engine;
determining whether a cooling logic entry condition of an engine block is satisfied based on a load state in relation to a revolutions per minute (RPM) value of the engine;
controlling a block-side opening amount of an integrated flow control valve connected to the engine based on whether the cooling logic entry condition is satisfied; and
determining a cooling logic escape condition of the engine block based on the load state in relation to the RPM value of the engine.

2. The method of claim 1, wherein the driving state information includes an RPM value of the engine, an accelerator pedal operation amount of the vehicle, and a percent (%) load value of the engine,
wherein determining the cooling logic entry condition includes deriving the load state based on the driving state information of the vehicle.

3. The method of claim 2, wherein determining the cooling logic entry condition further includes:
determining a first entry condition based on whether the accelerator pedal operation amount is greater than or equal to a reference accelerator pedal operation amount determined according to the RPM value of the engine; and
determining a second entry condition based on whether the percent load value of the engine is greater than or equal to a reference percent (%) load determined according to the RPM value of the engine.

4. The method of claim 3, wherein determining the cooling logic entry condition includes determining that the cooling logic entry condition is satisfied based on determining that a maintenance time in a high load state in which at least one of the first entry condition and the second entry condition is satisfied is longer than or equal to a preset reference maintenance time.

5. The method of claim 2, wherein determining of the cooling logic escape condition comprises:
determining a first escape condition based on whether the accelerator pedal operation amount is greater than or equal to a reference accelerator pedal operation amount determined according to the RPM value of the engine;
determining a second escape condition based on whether the percent load value of the engine is greater than or equal to a reference percent load determined according to the RPM value of the engine; and
counting an escape delay time from a point in time at which both the first escape condition and the second escape condition are not satisfied.

6. The method of claim 5, wherein determining the cooling logic escape condition includes determining that the cooling logic escape condition is satisfied based on determining that the escape delay time is longer than or equal to a preset reference delay time.

7. The method of claim 5, wherein during counting of the escape delay time, occurrence of a high-load state in which at least one of the first escape condition and the second escape condition is satisfied causes the escape delay time is reset.

8. The method of claim 1, wherein controlling the block-side opening amount of the integrated flow control valve includes:
controlling the block-side opening amount of the integrated flow control valve to a first set value to resume coolant flow to the engine block based on determining that the cooling logic entry condition is satisfied.

9. The method of claim 8, further comprising:
receiving coolant temperature information of an engine head,
wherein controlling the block-side opening amount of the integrated flow control valve further includes:
controlling the block-side opening amount of the integrated flow control valve to a second set value, which is less than the first set value, based on determining that the coolant temperature of the engine head is lower than a reference head temperature.

10. An engine cooling system, comprising:
an integrated flow control valve configured to distribute coolant flowing in from an engine through one or more inlets;
a plurality of circulation paths configured to circulate the coolant distributed by the integrated flow control valve into an internal path of the engine; and
a control unit configured to control the integrated flow control valve,
wherein the control unit is configured to:
determine a cooling condition of an engine block based on a load state in relation to a revolutions per minute (RPM) value of the engine, and
adjust an opening amount of a block-side inlet connected to the engine block based on whether the cooling condition is satisfied.

11. The engine cooling system of claim 10, wherein the control unit is configured to:
collect driving state information of a vehicle including the engine, and
derive the load state based on the driving state information of the vehicle.

12. The engine cooling system of claim 11, wherein the driving state information includes the RPM value of the engine, an accelerator pedal operation amount of the vehicle, and a percent (%) load value of the engine.

13. The engine cooling system of claim 12, wherein the control unit is configured to:
determine a first condition based on whether the accelerator pedal operation amount is greater than or equal to a reference accelerator pedal operation amount determined according to the RPM value of the engine, and
determine a second condition based on whether the percent load value of the engine is greater than or equal to a reference percent load determined according to the RPM value of the engine.

14. The engine cooling system of claim 13, wherein the control unit is configured to:
determine that a cooling logic entry condition of the engine block is satisfied when a maintenance time in a high load state in which at least one of the first condition and the second condition is satisfied is longer than or equal to a preset reference maintenance time, and
control the opening amount of the block-side inlet to a first set value to resume coolant flow to the engine block when the cooling logic entry condition is satisfied.

15. The engine cooling system of claim 14, further comprising:
a head coolant temperature sensor configured to detect a coolant temperature of in an engine head of the engine.

16. The engine cooling system of claim 14, wherein the control unit is configured to control the opening amount of the block-side inlet to a second set value, which is less than the first set value, when the measured value of the head coolant temperature sensor is lower than a reference head temperature.

17. The engine cooling system of claim 13, wherein the control unit is configured to:
count an escape delay time from a point in time at which both the first condition and the second condition are not satisfied, and
determine that a cooling logic escape condition is satisfied when the escape delay time is greater than or equal to a preset reference delay time.

18. The engine cooling system of claim 17, wherein the control unit is configured to reset the escape delay time when a high load state, in which at least one of the first condition and the second condition is satisfied, occurs.

19. A vehicle, comprising:
an engine including a block and a head;
an integrated flow control valve configured to distribute coolant flowing in through at least one of a block-side inlet and a head-side inlet to a plurality of outlets;
a plurality of circulation paths configured to circulate the coolant distributed to the plurality of outlets into an internal path of the engine; and
a control unit configured to control the integrated flow control valve,
wherein the control unit is configured to:
determine a cooling condition of the block based on a load state relative to a revolutions per minute (RPM) value of the engine, and
control an opening amount of the block-side inlet based on whether the cooling condition is satisfied.

20. The vehicle of claim 19, further comprising:
a head coolant temperature sensor configured to detect a coolant temperature in the head,
wherein the control unit is further configured to control the opening amount of the block-side inlet based on a measured value of the head coolant temperature sensor.
